(19) United States
(12) Patent Application Publication
(10) Pub. No.: US 2002/0138651 A1
(43) Pub. Date: Sep. 26, 2002

(54) Processing of an IP address at the system level

(76) Inventors: Gebhard Oelmaier, Muehldorf (DE); Egid Pichlmair, Bockhorn (DE)

Correspondence Address: Kevin R. Spivak, Morrison & Foerster LLP, Suite 5500, 2000 Pennsyvania Avenue, N.W., Washington, DC, 20006-1888, US

(21) Appl. No.: 10/074,233

(22) Filed: Feb. 14, 2002

(30) Foreign Application Priority Data
Feb. 15, 2001 (EP) 01103776.9

(51) Int. Cl. G06F 15/16

(52) U.S. Cl. 709/245

(57) ABSTRACT

The invention relates to a method and a system which provides a routine for converting the formats of an IP address at a central location in the system. In this way, the conversion of formats is introduced as a standard for all IP-based applications programs. The system component is formed by a specially adapted operating system, an extended compiler or by a specific hardware microprocessor.

### CLAIM FOR PRIORITY

This application claims priority to Application No. 01103776.9 which was published in the English language on Feb. 15, 2001.

### TECHNICAL FIELD OF THE INVENTION

The invention relates to data communication via a network such as the Internet, and in particular, to a method and system in which at least one routine for processing IP addresses is made available.

### BACKGROUND OF THE INVENTION

Because communication via the Internet is becoming increasingly important, the development of Internet-specific programs is likewise assuming increasing importance.

If, for example, two machines which can be accessed via the Internet exchange data, it is necessary first to establish the basis on which they can communicate with one another. For this purpose, each machine which can be accessed via the Internet is assigned a unique address. The address is composed at present (in the IPv4 protocol) of four numbers whose value is between 0 and 255. In order to make the designation simpler and easier to remember, names are used which are in turn assigned to these numerical addresses.

In order to make network architectures as compatible as possible, an International Standard, referred to as the OSI reference model (Open Systems Interconnection) has been introduced by the “International Standards Organization ISO”. The underlying idea for this model of standards is to divide the network architecture into hierarchically structured layers which are built up one on top of the other. In this context, a specific layer of a machine communicates with the corresponding layer of the other machine. The rules on the basis of which this communication occurs are defined in a protocol:

the known IP (Internet Protocol) switching protocol is based on transparent Internet datagrams and is basically independent of connections.

The IP protocol has basically the following sequence:

the transport layer receives messages and divides them into datagrams which can be transmitted via the Internet. When all the datagrams have reached the destination machine, they are combined by the transport layer there so that the original message can be called.

An IP header is placed at the start of each message and is composed of a plurality of entries which comprise the source address and the destination address. The addresses give the network number and host number.

An IP address is basically a 32-bit address (=4 byte address) which is composed of a network identifier and a host address. A four-point notation has become customary as a format for the individual addresses. The four individual bytes of the address are each separated by a point. Specific regions are defined for the network identifier and the identifier of the host address. These two regions are of variable size. Basically, four different representation possibilities are used for these. They permit a different number of networks and hosts to be coded.

In order, on the one hand, to increase the efficiency of the transmission of a message via a network it is important to keep the ratio between the IP header and the actual message as small as possible. To do this, the memory space necessary for the representation of the IP address must be kept as small as possible. For this reason, IP addresses are frequently transmitted in a compressed, packed form.

On the other hand, it is necessary also to process an uncompressed format, that is to say an explicit format or an explicit representation.

For this reason, in virtually all IP-based solutions it is necessary to process, and in particular convert, the different IP address formats (for example the conversion—of the explicit representation into the compressed one, and vice versa).

Furthermore, there is an immense need to execute the processing of IP addresses with maximum performance levels, especially when considering the amount of IP address processing. This is because the processing of IP addresses constitutes a factor which significantly determines the performance of the system as a whole. If the processing—for example the conversion—of an IP address is delayed, the application based on it is also inevitably delayed. This state of affairs is not tolerable for performance reasons.

In order to process IP addresses in an optimized way, in addition to the explicit format (11 bytes with a hexadecimal representation, 15 bytes with a decimal representation), a compressed format (for example a 32-bit word—4 bytes) is additionally used which makes it possible to transfer the data in packed form. If such an IP address is then to be processed within the scope of an application, conversion from one format into the other is virtually always necessary. It is therefore necessary to make available a routine for conversion from the explicit format into the compressed format, and from the compressed format into the explicit format.

Routines, with corresponding conversion functionality, are typically provided individually and independently of one another in each application software. However, because the routine for format conversion of IP addresses is, on the one hand, required very frequently and, on the other hand, is very time-critical, the previous procedure, namely providing the routine in a decentralized fashion, is not appropriate.

This procedure also proves disadvantageous for reasons of performance.

Routines are also provided in program libraries, for example DLL (Dynamic Link Library) files. In this context, U.S. Pat. No. 5,634,114 discloses a method which controls the correct assignment of a DLL file and an applications program which calls this file. This is because different versions of a DLL file are frequently stored in such a program library. If the application requires a quite specific version of this DLL file, the selection of the suitable DLL file is monitored by this method.

The possibility of placing a routine in a program library is, however, only one of the possible measures provided by the present invention for providing a format conversion routine for IP addresses at a central location in the system and at the system level (and no longer at the level of the applications program).

It is also disadvantageous that a separate IP address processing routine had to be written, compiled and tested in each for each individual IP application. This increases the probability of errors and leads to redundant development work.

### SUMMARY OF THE INVENTION

The present invention makes available a method and corresponding system which permit the fastest possible processing of IP addresses, in particular of their formats, without a separate routine having to be generated and compiled for each applications program, with the result that the routine can serve as a standard for a plurality of IP applications.

In one embodiment, a routine is provided for processing IP addresses, in particular a conversion routine for different formats of IP addresses, at a central location or within a computer system, and does not need to be programmed and compiled individually and anew for each individual IP application. Integration of the routine at the system level or into a system component can be carried out by integrating the routine into an operating system.

In one aspect of the invention, the routine is integrated in a compiler which brings about a corresponding call of a routine in the operating system, if the latter supports this. Otherwise, the compiler may include a specific processor code which executes the processing of IP address formats, in particular their conversion. Likewise, an assembler or interpreter which is configured for processing, in particular converting, IP addresses lies within the scope of the invention.

In another aspect, the routine is implemented for processing IP addresses in hardware. For this purpose, at least one register is provided whose contents is subjected to corresponding computing operations which supply the desired result. Such components which permit there to be just one clock cycle between the input and the output are used. This leads to a significantly increased performance.

There are various versions of the Internet Protocol (for example the currently customary IPv4 and its successive development IPv6). A main difference between version 4 and version 6 is the enlargement of the IP address space. As a result of the expansion of the address length from previously 32 bits to 128 bits, an enormously high number of possible addresses is produced. It goes without saying that as a result the necessary computing power for the processing of these addresses also rises. A necessity of making available a means of efficiently processing the more complex IPv6 addresses also arises from this. In one preferred embodiment of the invention, the method is therefore applied to the IPv6. The invention may also be applied to similar standards as readily understood by the skilled artisan.

The method according to the invention provides the advantage that each individual user routine for processing the IP addresses does not need to be tested individually but rather the routine is made available once at a central location. This reduces the outlay on testing and increases the performance.

Because any generation of program code is also associated with a certain probability of errors, the fact that the IP processing code only needs to be made available once as a standard has a positive effect on the error balance.

The invention is achieved not only by the method according to the invention but also by a system which is adapted and expanded according to the invention in a specific way and which provides for the conversion of IP address formats at a central location within the system.

The system can be an expanded operating system, an expanded compiler (or assembler or interpreter) or a specific hardware implementation.

Another embodiment of the invention relates to a compiler with a library which may include a routine for processing IP addresses.

In a further advantageous embodiment of the invention, the system is formed from a specific protocol processor, for example an ASIC (Application-Specific Integrated Circuit). These hardware modules are either configured specifically for the one application, in this case the format conversion of IP addresses, or the format conversion is integrated into an ASIC from another environment.

The inventive exporting of the routine functionality from the applications level to the system level is advantageously independent of the processor and can be used for different environments.

The subject-matter of the invention not only comprises the functionality of the routine for converting IP address formats which is described above but also a routine which has a different functionality during the processing of IP addresses. For example, the incrementation or decrementation of IP addresses is thus also included.

In still another embodiment of the invention, there is a program on a recordable medium that performs processing in accordance with the above described system and method.

### BRIEF DESCRIPTION OF THE DRAWINGS

Further advantages of the invention and particular embodiments with their features are represented in the following detailed description of the figures, of which:

FIG. 1a illustrates a compressed representation of a format of an IP address.

FIG. 1b illustrates a representation of the format of the IP address.

FIG. 2 is an exemplary flowchart relating to the execution of the method according to a preferred embodiment of the invention.

### DETAILED DESCRIPTION OF THE PREFERRED EMBODIMENTS

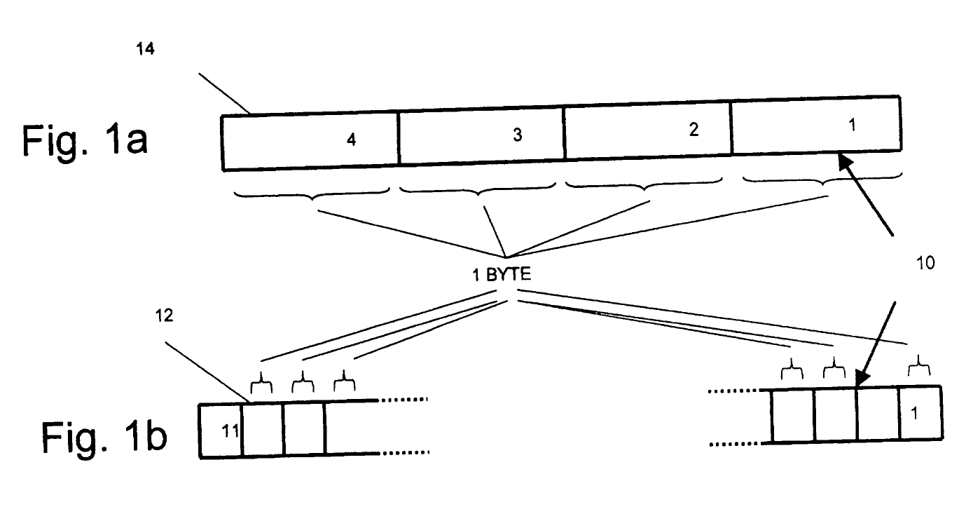

An example of a representation of an IP address designated generally by 10 is given below with reference to FIG. 1.

FIG. 1a shows a customary 32-bit representation or a 4-byte representation. This representation is referred to below as a compressed format 14 or compressed representation 14. The schematic representation illustrated in FIGS. 1a and 1b relates in each case to Little Endian computers in which the memory blocks are numbered from right to left.

The individual blocks can assume numerical values from 0 to 255, that is to say a total of 256 characters.

An IP address 10 can be assigned once worldwide in order to permit a unique assignment between the IP address 10 and the corresponding computer.

If IP addresses 10 are to be processed, it is appropriate for performance reasons to select a compressed or packed representation 14. However, in addition to this format, an explicit format 12 is also used which is schematically illustrated in FIG. 1b and is larger than the compressed format 14 of the IP address 10. For performance reasons, the compressed format 14 is advantageously used for the transfer of data. However, it may also be necessary to transfer the explicit format 12 for standardization reasons, the format 12 being otherwise usually used for outputting on the terminal. In all IP-based applications it is necessary to convert the various formats 12, 14 of the IP address 10 irrespective of the particular application.

FIG. 1b shows example of an explicit format 12, which is represented here in hexadecimal form and comprises 11 bytes.

In order to permit an efficient transfer of data of IP addresses 10, it is necessary to convert from the explicit format 12 into the compressed format 14, and vice versa.

A corresponding routine 16 which provides such a conversion functionality always had to be re-coded for each individual applications program which processes IP addresses 10, compiled and linked to other object files to form an executable applications program code.

For various reasons, this procedure proves disadvantageous because the repeated execution of an identical procedure increases the occurrence of errors. For this reason, standardization of the conversion functionality is appropriate.

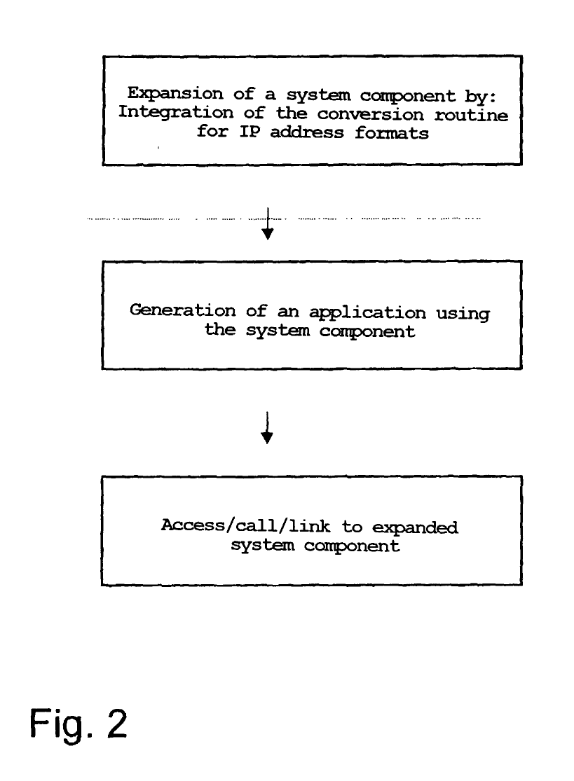

As is illustrated in FIG. 2, according to the invention the routine 16, in particular the conversion routine 16, is arranged at a central location of the computer system and thus exported from the applications level to the system level. This is made possible by the fact that the routine 16 is integrated into a system component 18, 20, 22 which is by definition a fixed component of the system. The expansion of the system component 18, 20, 22 takes place chronologically before the generation of the applications code and is therefore separated off in the drawing from the chronologically following areas by a dashed line. The system component can, for example:

1. be a compiler 18 (or an assembler) which comprises this functionality of the conversion of IPP address format,

2. an operating system 20 which comprises the functionality of the conversion of IP address formats, and

3. a microprocessor 22 which already provides the functionality of the conversion of IP address formats at the hardware level.

Of course, the scope of this invention includes other embodiments which also permit a routine 16 for converting IP address formats to be integrated in a central system component.

If the routine 16 is to be integrated into the compiler 18, this can be effected by calling a corresponding operating system routine if the operating system supports this conversion functionality. Otherwise, the corresponding processor code is generated. The scope of the invention also includes use of a library which is accessed via a compiler call and which carries out an additional conversion function of IP addresses 10, for example a specific DLL (Dynamic Link Library) file “IP₁₃convert”.

In a preferred embodiment, the routine 16 needs to be compiled and linked only once, namely within the scope of the integration procedure. This leads to a significantly improved performance, to a more positive working memory balance and reduces the probability of errors.

The invention is achieved not only with the method according to the invention but also with a specifically adapted system 18, 20, 22 which provides for the conversion of IP address formats 12, 14 at a central location within the system.

In particular, the operating system 20 can be expanded with a central conversion routine 16 of IP addresses 10.

In time-critical applications, the performance is particularly important. Under these circumstances, it may be preferable to provide the routine 16 at the hardware level at a central location in the system. For this purpose, a microprocessor 22 with memory elements (RAM, ROM, EEPROM), in particular at least one register, at least one arithmetic unit, an I/O unit and one data and address bus is used, which microprocessor 22 additionally has a processing unit, in particular a conversion unit for IP address formats. The processing unit preferably comprises a register whose contents can be processed with the smallest clock pulse number possible.

What is claimed is:

1. A method for providing at least one routine for processing an IP address to convert different formats of the IP address, the routine generating a multiplicity of applications programs, comprising:
integrating the routine in at least one system; and
providing a link or an access in the applications programs.

2. The method as claimed in claim 1, wherein the routine is a conversion routine for the formats of the IP address.

3. The method as claimed in claim 1, further comprising:
converting the routine to different formats of the IP address into an explicit format for representing the IP address, and a compressed format for the transfer of data.

4. The method as claimed in claim 1, wherein routine is based on the Internet Protocol IPv4 and processes associated address formats.

5. The method as claimed in claim 1, wherein the routine is based on the Internet Protocol IPv6 and processes associated address formats.

6. The method as claimed in claim 1, further comprising integrating the routine in the system such that the routine is not complied when an executable applications program code is generated.

7. The method as claimed in claim 1, wherein a component of the system is an operating system which serves as an environment for the applications program.

8. The method as claimed in claim 1, wherein a component of the system is a compiler or an assembler or an interpreter which is used to compile the applications program.

9. The method as claimed in claim 1 wherein a component of the system component is a microprocessor which executes the routine and/or the applications program.

10. The method according to claim 1, wherein a system component processes an IP address for conversion of different formats of the IP address.

11. The method according to claim 8, wherein the compiler processes an IP address into the format of the IP address.

12. The compiler as claimed in claim 11, wherein a library which the compiler accesses during the compiling operation has a module which processes an IP address in the format of the IP address.

13. The method of claim 1, wherein a microprocessor processes an IP address in the formats of the IP address) by subjecting the contents of at least one register to specific processing operations.

14. A computer readable medium storing a routine for providing at least one routine for processing an IP address to convert different formats of the IP address, the routine generating a multiplicity of applications programs, comprising:
integrating the routine in at least one system; and
providing a link or an access in the applications programs.

15. The computer readable medium as claimed in claim 1, wherein the routine is a conversion routine for the formats of the IP address.

16. The computer readable medium as claimed in claim 1, wherein the routine further comprises:
converting the routine to different formats of the IP address into an explicit format for representing the IP address, and a compressed format for the transfer of data.

17. The computer readable medium as claimed in claim 1, wherein routine is based on the Internet Protocol IPv4 and processes associated address formats.

18. The computer readable medium as claimed in claim 1, wherein the routine is based on the Internet Protocol IPv6 and processes associated address formats.

19. The computer readable medium as claimed in claim 1, wherein the routine further comprises integrating the routine in the system such that the routine is not complied when an executable applications program code is generated.
